(19) United States
(12) Patent Application Publication
(10) Pub. No.: US 2010/0094820 A1
(43) Pub. Date: Apr. 15, 2010

(54) METHOD FOR AFFECTING THE SCORE AND PLACEMENT OF MEDIA ITEMS IN A LOCKED-TO-TOP PLAYLIST

(75) Inventor: Sean T. Purdy, Durham, NC (US)

Correspondence Address: WITHROW & TERRANOVA CT, 100 REGENCY FOREST DRIVE , SUITE 160, CARY, NC, 27518, US

(73) Assignees: CONCERT TECHNOLOGY CORPORATION, Durham, NC (US); NAPO ENTERPRISES, LLC, WILMINGTON, DE (US)

(21) Appl. No.: 12/250,019

(22) Filed: Oct. 13, 2008

(51) Int. Cl. G06F 17/00

(52) U.S. Cl. 707/705; 707/E17.005

(57) ABSTRACT

Methods and systems are disclosed for affecting a score of a media item in a playlist of scored media items. In one embodiment, a playlist of scored media items that is sorted based on score is provided. An associated user is enabled to adjust the score of a media item in the playlist by moving the media item up or down in the playlist. In another embodiment, a playlist of scored media items is provided. The associated user is enabled to directly adjust the score of a media item in the playlist via a score adjustment control. In yet another embodiment, media items in a playlist are scored based on one or more user preferences of the associated user. The playlist may or may not be sorted based on score. Adjustments are made to the user preferences based on detected user events such as, for example, score adjustment events.

### FIELD OF THE INVENTION

The present invention relates to a playlist of scored media items, and more particularly relates to affecting scores of media items in a playlist of scored media items.

### BACKGROUND OF THE INVENTION

U.S. Patent Application Publication No. 2008/0016205, entitled P2P NETWORK FOR PROVIDING REAL TIME MEDIA RECOMMENDATIONS, discloses a peer-to-peer (P2P) media recommendation system. In that P2P media recommendation system, in one embodiment, a user is presented with a playlist of media items, where the media items in the playlist are scored based on user preferences of the user and the playlist is sorted based on the scores of the media items. In such a system where the user is presented with a playlist of scored media items, there is a need for a system and method that enable the user to quickly and easily affect the scores of the media items in the playlist.

### SUMMARY OF THE INVENTION

The present invention relates to affecting a score of a media item in a playlist of scored media items. In one embodiment, a playlist of scored media items that is sorted based on score is provided. User input selecting a group of one or more media items in the playlist is received from an associated user. User input is then received from the associated user moving the group of one or more media items up or down in the playlist such that each media item in the group of one or more media items is moved from an original location within the playlist to a new location within the playlist. For each media item in the group of one or more media items selected by the associated user and moved up or down in the playlist, a modifier is applied to an original score for the media item to provide an adjusted score for the media item that corresponds to the new location of the media item within the playlist. The score adjustments may be temporary or permanent.

In another embodiment, a playlist of scored media items is provided. In this embodiment, the playlist may or may not be sorted based on score. Each media item in the playlist has a corresponding score adjustment control by which an associated user can directly adjust the score of the media item. User input directly adjusting a score of a media item in the playlist is received from the associated user via a corresponding score adjustment control. In response, the score of the media item is adjusted. If the playlist is sorted based on score, the media item is relocated within the playlist to the appropriate location based on the adjusted score of the media item.

In yet another embodiment, media items in a playlist are scored based on one or more user preferences of an associated user to provide a playlist of scored media items. The playlist may or may not be sorted based on score. User events associated with the playlist are detected and recorded in a log. The user events may include score adjustment events corresponding to adjustments to the scores of the media items by the associated user by moving the media items up or down in the playlist and/or via corresponding score adjustment controls. In addition, the user events may include skipping a media item in the playlist, completely playing a media item in the playlist, deleting a media item from the playlist, or the like. The log of user events is analyzed to determine whether to adjust the user preferences of the associated user. If a determination is made to adjust the user preferences of the associated user, the user preferences are adjusted, and at least a subset of the media items in the playlist affected by the adjustment(s) to the user preferences are rescored.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a flow chart illustrating a process for affecting a score of a media item in a playlist of scored media items according to a first embodiment of the present invention;

FIGS. 2A through 2P graphically illustrate the process of FIG. 1 according to an exemplary embodiment of the present invention;

FIG. 3 is a flow chart illustrating a process for affecting a score of a media item in a playlist of scored media items according to a second embodiment of the present invention;

FIGS. 4A through 4E graphically illustrate the process of FIG. 3 according to an exemplary embodiment of the present invention;

FIG. 5 is a flow chart illustrating a process for affecting a score of media items in a playlist of scored media items according to a third embodiment of the present invention;

FIGS. 6A through 6E graphically illustrate an exemplary use case with respect to the process of FIG. 5;

FIG. 7 is a functional block diagram of a user device including a media player function in which one or more score adjustment schemes of FIGS. 1, 3, and 5 are implemented according to one embodiment of the present invention; and

FIG. 8 is a block diagram of an exemplary implementation of the user device of FIG. 7.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

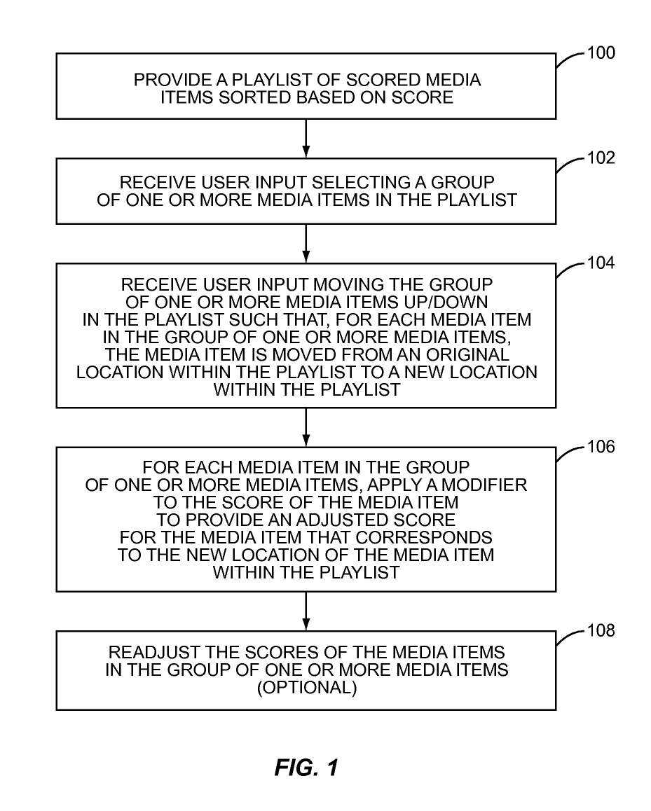

FIG. 1 is a flow chart illustrating a process for affecting a score of a media item in a playlist of scored media items according to one embodiment of the present invention. First, a playlist of scored media items that is sorted based on score is provided (step 100). In this embodiment, since the playlist is sorted, the playlist is also referred to as a sorted playlist. The media items in the playlist are preferably songs. However, the present invention is not limited thereto. The playlist may include any type of media items or any combination of types of media items. For example, the media items in the playlist may be audio items such as, but not limited to, songs, audio clips, or podcasts; video items such as, but not limited to, television programs, movies, video clips; the like; or any combination thereof.

In the preferred embodiment, the media items in the playlist are scored based on one or more user preferences of an associated user. The user preferences may be any type of user preferences related to media items, and the media items in the playlist may be scored based on or as a function of the user preferences using any suitable scoring technique. As one exemplary embodiment, the media items in the playlist may include media items from a media collection of the associated user and media items recommended to the associated user by a number of other users automatically in response to the recommended media items being played by the other users in the manner described in U.S. Patent Application Publication No. 2008/0016205, entitled P2P NETWORK FOR PROVIDING REAL TIME MEDIA RECOMMENDATIONS, which was filed on Jul. 11, 2006, published on Jan. 17, 2005, and is hereby incorporated herein by reference in its entirety.

As discussed in U.S. Patent Application Publication No. 2008/0016205, in one embodiment, the user preferences include weights assigned to a number of metadata categories and, for each metadata category, weights assigned to a number of attributes within that metadata category. More specifically, assuming that the media items are songs, the metadata categories may include genre, decade, availability, and user, each of which may be assigned a weight of, for example, 1 to 10. For the genre category, weights may be separately assigned to a number of genres such as, for example, Rock, Jazz, Country, Pop, Alternative, or the like. For the decade category, weights may be separately assigned to a number of decades such as, for example, the 1960s, 1970s, 1980s, 1990, and 2000s. For the availability category, weights may be separately assigned to a number of sources such as “local,” “buy,” “subscription network,” or the like. For the user category, weights may be separately assigned to a number of other users from which the associated user is receiving or has received recommendations.

Using these user preferences, an exemplary equation for scoring a particular media item is:

Score=NRF·(WU·WUA+WG·WGA+WD·WDA+WA·WAA)100,

where NRF is a “no repeat factor” which is discussed below; WU is the weight assigned to the user category; WUA is the weight assigned to a user attribute of the media item being scored; WG is the weight assigned to the genre category; WGA is the weight assigned to a genre attribute of the media item being scored, which is the genre of the media item; WD is the weight assigned to the decade category; WDA is the weight assigned to the decade attribute of the media item being scored, which is the decade in which the media item was released or created; WA is the weight assigned to the availability category; and WAA is the weight assigned to an availability attribute of the media item being scored, which is the availability of the media item.

The NRF is generally a factor applied to a score of a media item after the media item is played in order to ensure that the media item having the highest score is not repeatedly played. This is particularly beneficial in a locked-to-top embodiment where the playlist is sorted based on score and the media item at the top of the playlist is automatically selected for playback. The NRF may, for example, be computed as:

$$N R F = \frac{MIN ( 10 \cdot N R F W , LASTREPEAT\_INDEX )}{10 \cdot N R F W} ,$$

where NRFW is a weight assigned to the NRF and LASTREPEAT_INDEX is the number of media items from the playlist that have been played since the media item was last played.

As an example, assume that the following category weights have been assigned:

| | |
|---|---|
| User Category | 1 |
| Genre Category | 7 |
| Decade Category | 7 |
| Availability Type Category | 5 |
| NRFW | 9 |

Therefore, WU is 1/20, WG is 7/20, WD is 7/20, and WA is 5/20. Note that the denominator, 20, is a sum of the numerators of WU, WG, WD, and WA. Further, assume that the attributes for the categories have been assigned weights as follows:

| User | | Genre | | Decade | | Availability | |
|---|---|---|---|---|---|---|---|
| User A | 5 | Alternative | 8 | 1950s | 2 | Local | 8 |
| User B | 5 | Classic Rock | 5 | 1960s | 4 | Subscription Network | 2 |
| User C | 5 | Arena Rock | 5 | 1970s | 7 | Buy/Download | 1 |
| | | Jazz | 5 | 1980s | 9 | Find | 1 |
| | | New Wave | 2 | 1990s | 5 | | |
| | | Punk | 4 | 2000s | 5 | | |
| | | Dance | 2 | | | | |
| | | Country | 2 | | | | |

Thus, if a particular media item to be scored is a song recommended by the user “User C,” is from the “Alternative Genre,” is from the “1980s” decade, and is available from a subscription music service, the score of the song may be computed as:

$$Score = N R F \cdot ( \frac{1}{20} \cdot \frac{5}{10} + \frac{7}{20} \cdot \frac{8}{10} + \frac{7}{20} \cdot \frac{9}{10} + \frac{5}{20} \cdot \frac{2}{10} ) \cdot 100 ,$$

where if the song was last played 88 songs ago,

$$N R F = \frac{MIN ( 10 \cdot 9 , 88 )}{10 \cdot 9} = \frac{88}{90} .$$

Thus, the score for the song is

$$Score = \frac{88}{90} \cdot ( \frac{1}{20} \cdot \frac{5}{10} + \frac{7}{20} \cdot \frac{8}{10} + \frac{7}{20} \cdot \frac{9}{10} + \frac{5}{20} \cdot \frac{2}{10} ) \cdot 100 = 65.5 .$$

Again, the exemplary user preferences and scoring technique discussed above are exemplary and are not intended to limit the scope of the present invention. Any type of user preferences and scoring technique for scoring media items based on the user preferences may be used.

At some point, user input selecting a group of one or more media items in the sorted playlist is received from the associated user (step 102). User input is then received moving the group of one or more media items up or down the sorted playlist such that, for each media item in the group of one or more media items, the media item is moved from an original location of the media item within the sorted playlist to a new location of the media item within the sorted playlist (step 104). In response, for each media item in the group of one or more media items selected and moved by the associated user, a modifier is applied to the score of the media item to provide an adjusted score for the media item that corresponds to the new location of the media item within the sorted playlist (step 106).

Thus, for example, if a first media item having an original score of 65 is moved up in the playlist between a second media item having a score of 85 and a third media item having a score of 90, then a modifier of 21 may be added to the original score of the first media item such that the adjusted score of the first media item is 86. Note that while the modifier is additive in this example, the present invention is not limited thereto. Further, while in this example the modifier is 21 such that the adjusted score of the media item is one point greater than that of the second media item, the modifier may be any value greater than or equal to the score of the second media item (85) and less than or equal to the score of the third media item (90). As another example, if a first media item having an original score of 90 is moved down in the playlist between a second media item having a score of 70 and a third media item having a score of 65, then a modifier of −21 may be added to the original score of the first media item such that the adjusted score of the first media item is 69. Again, while in this example the modifier is −21 such that the adjusted score of the media item is one point less than that of the second media item, the modifier may be any value less than or equal to the score of the second media item (70) and greater than or equal to the score of the third media item (65).

Optionally, for each media item in the group of one or more media items selected and moved within the playlist by the associated user, the adjusted score of the media item may be readjusted back to the original score gradually over time, in response to an event such as playback of the media item, or a combination thereof (step 108). In other words, the adjustments made to the scores of the media items may be temporary. As a first example, the modifier for the score of a media item may be removed or set to zero after the media item has been played. Note that if a NRF is used, the score of the media item may be reduced after playback due to the NRF and then recharge or increase over time back to the original score rather than the adjusted or modified score.

As a second example, a reduction factor may be applied to the modifier of the score of a media item such that the modifier is gradually removed over time. More specifically, as an example, the reduction factor may be defined as:

Reduction Factor=1−Min(100, #_of_playbacks_since_modification)./100

As such, the adjusted score for the media item may be defined as:

Adjusted_Score=Original_Score+(Modifier·Reduction_Factor).

Thus, using this exemplary reduction factor and additive modifier, the adjusted score will gradually return to the original score as media items from the playlist are played and will be equal to the original score after 100 media items from the playlist have been played. As a third example, the reduction factor may be applied to the modifier of a media item, but after the media item is played, the modifier for the score of the media item may immediately be removed or set to zero. In other words, rather than continuing to gradually reduce the modifier after the media item is played, the modifier may be immediately removed or set to zero after the media item is played.

In the discussion of step 108 above, the modifiers applied to the scores of the media items are temporary modifiers. However, in an alternative embodiment, the modifiers applied to the scores of the media items may be permanent modifiers or the scores of the media items may otherwise be permanently adjusted. However, the associated user may thereafter change the permanent modifiers or permanently adjust the scores of the media items by again moving the media items up or down in the sorted playlist.

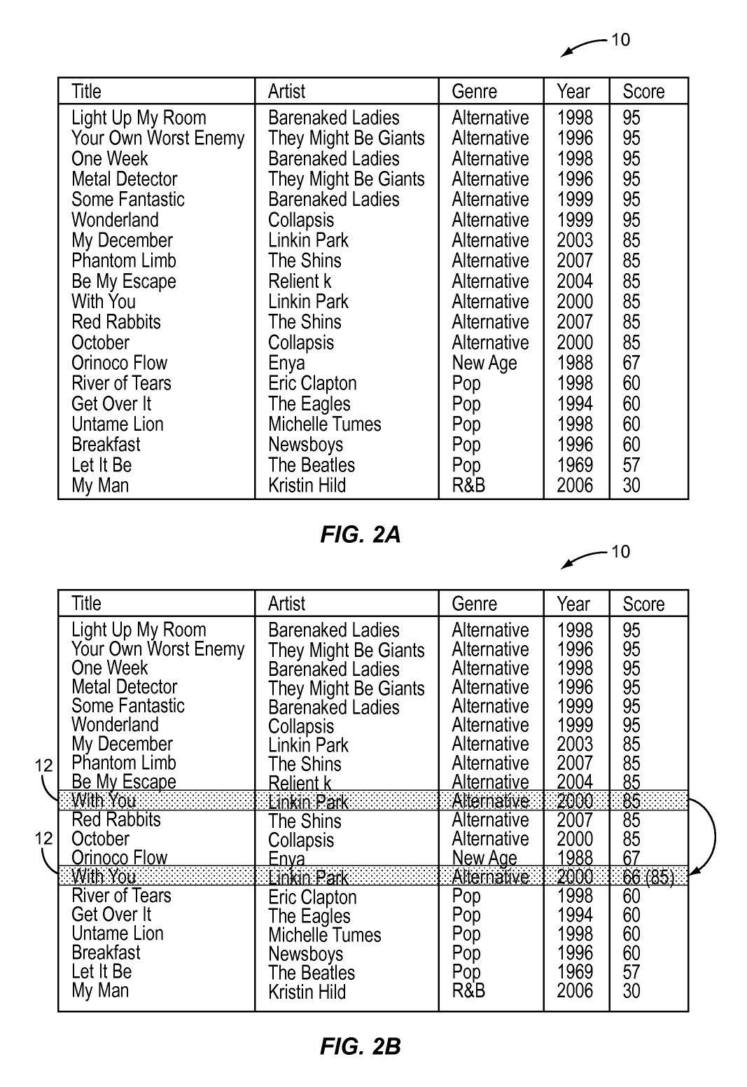

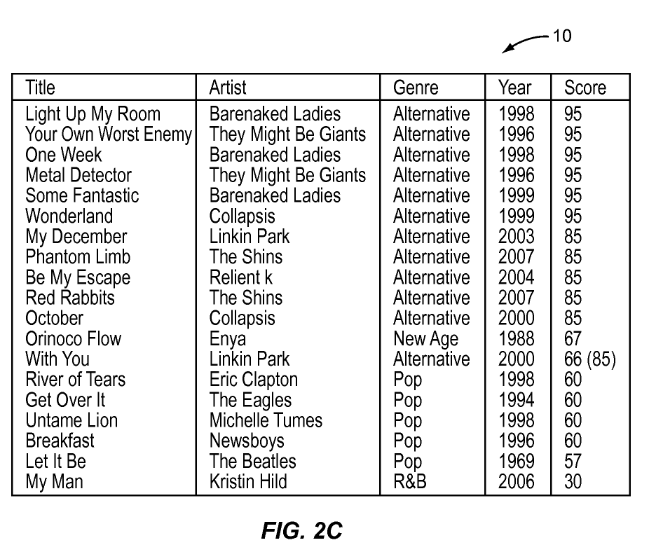

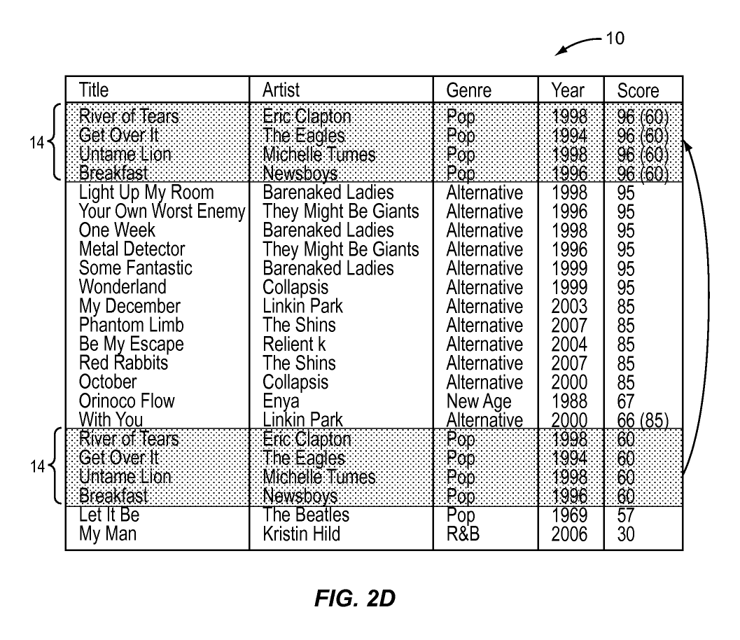

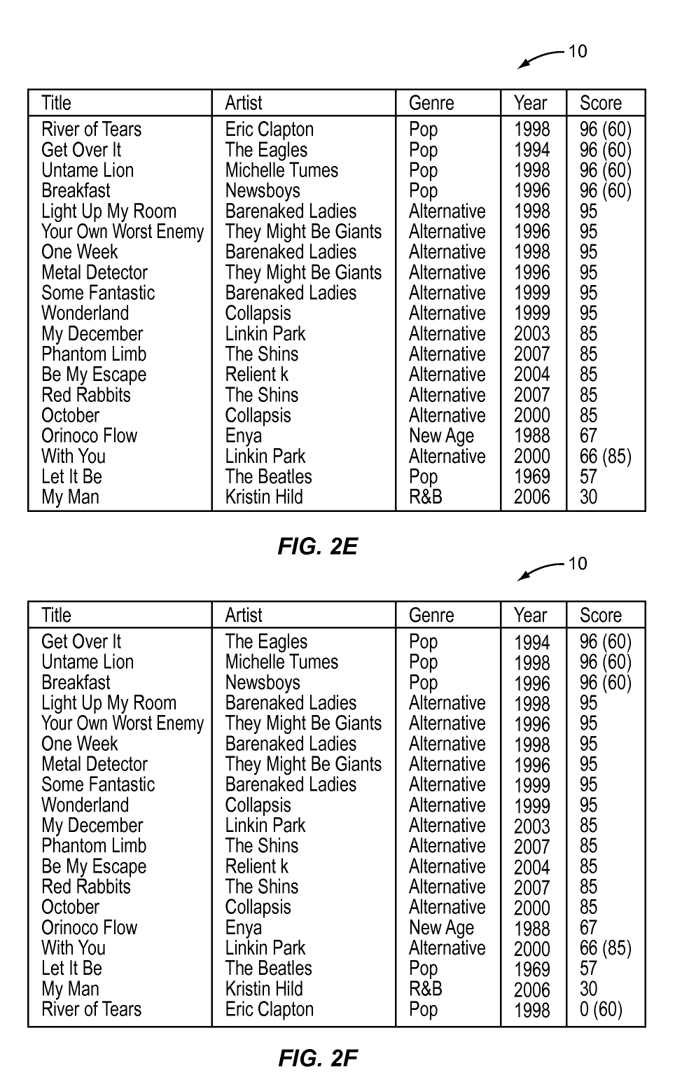

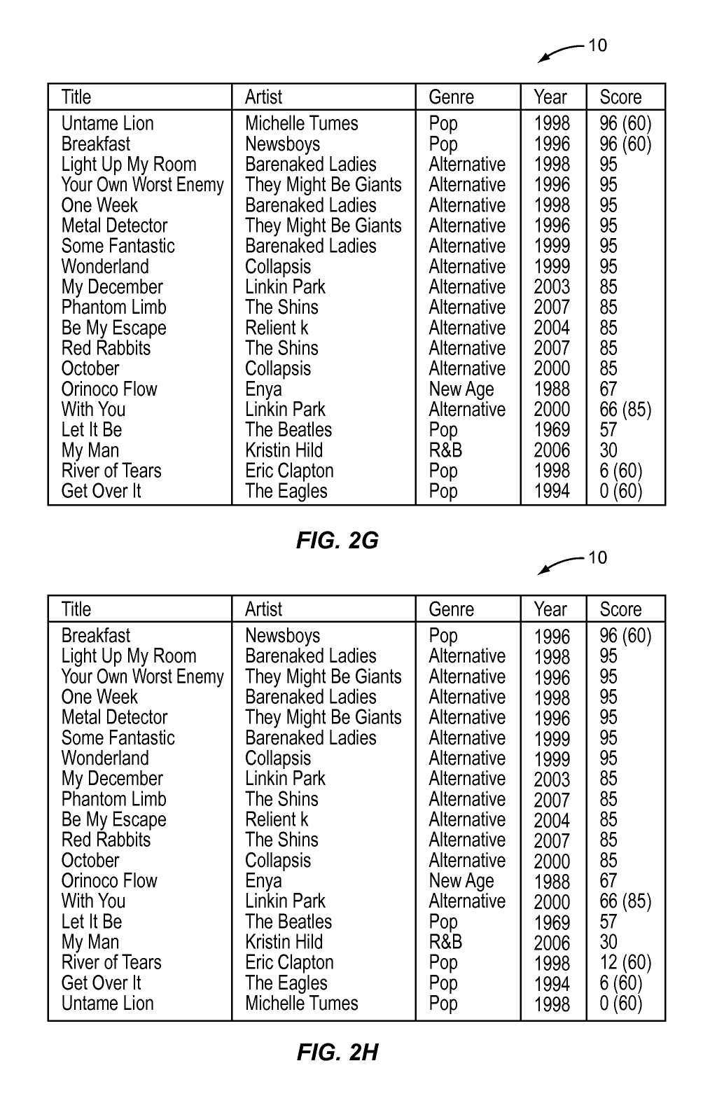

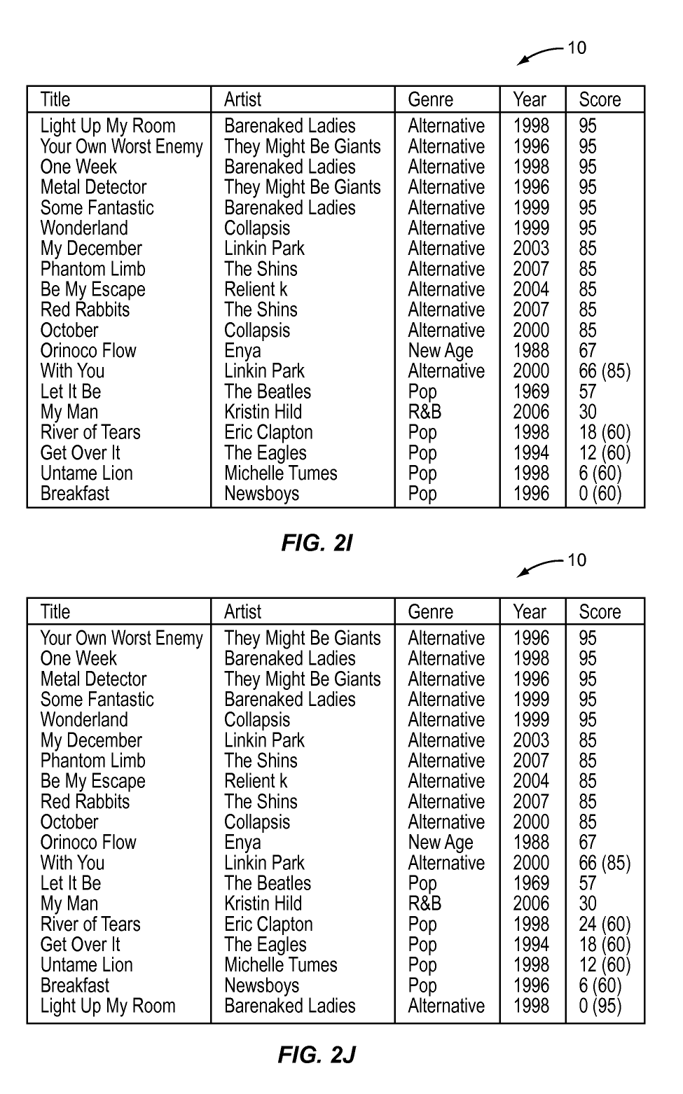

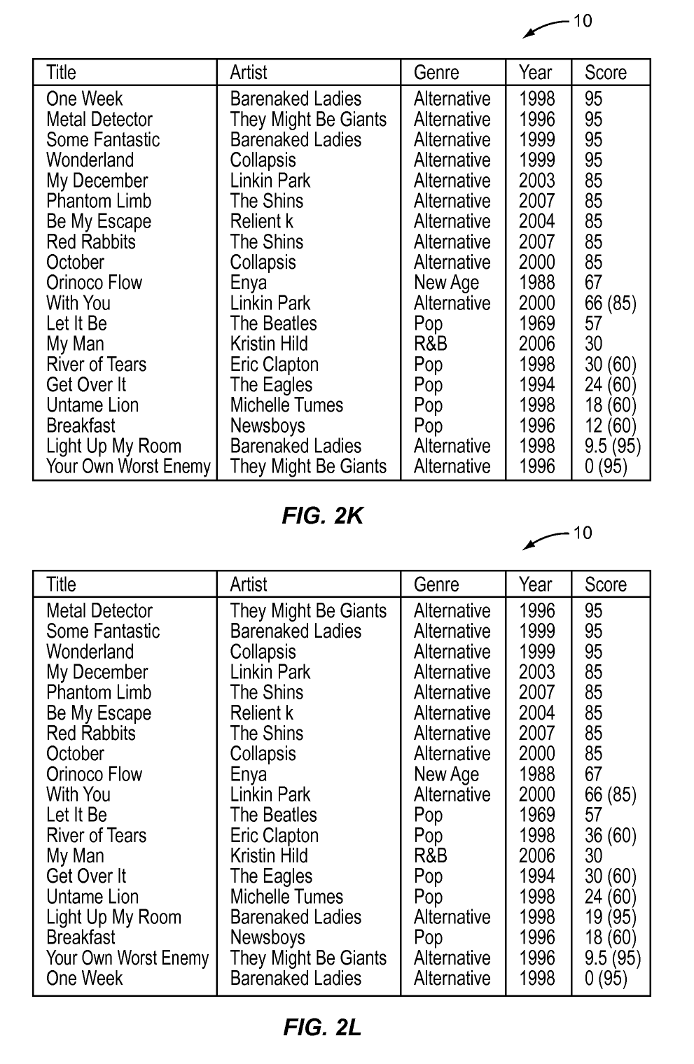

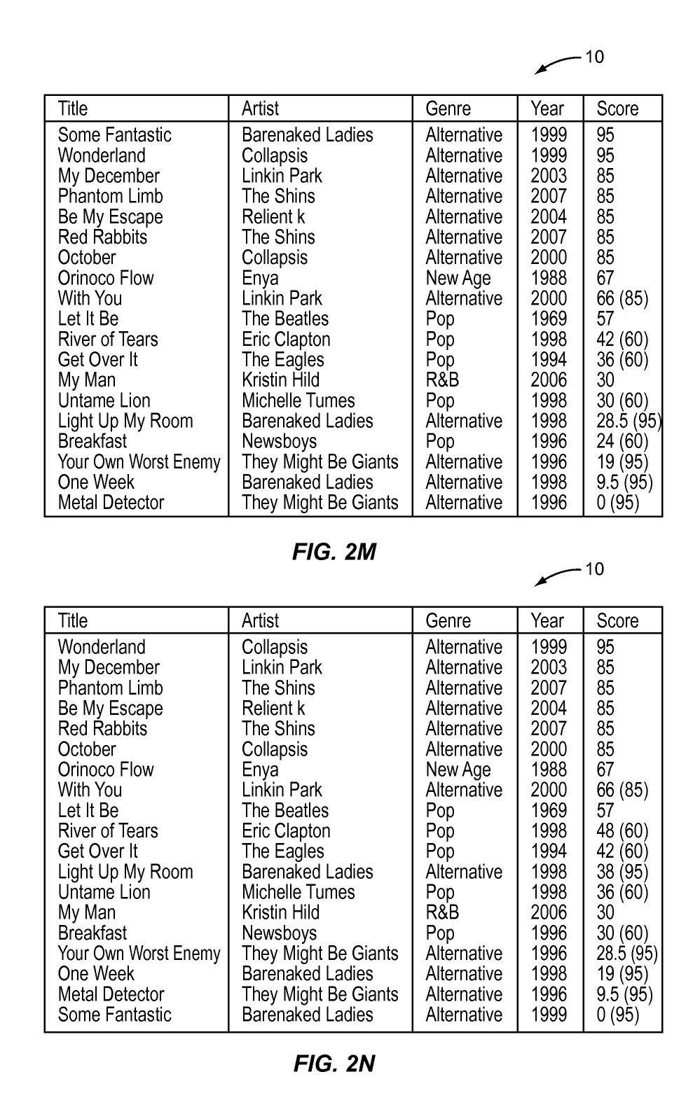

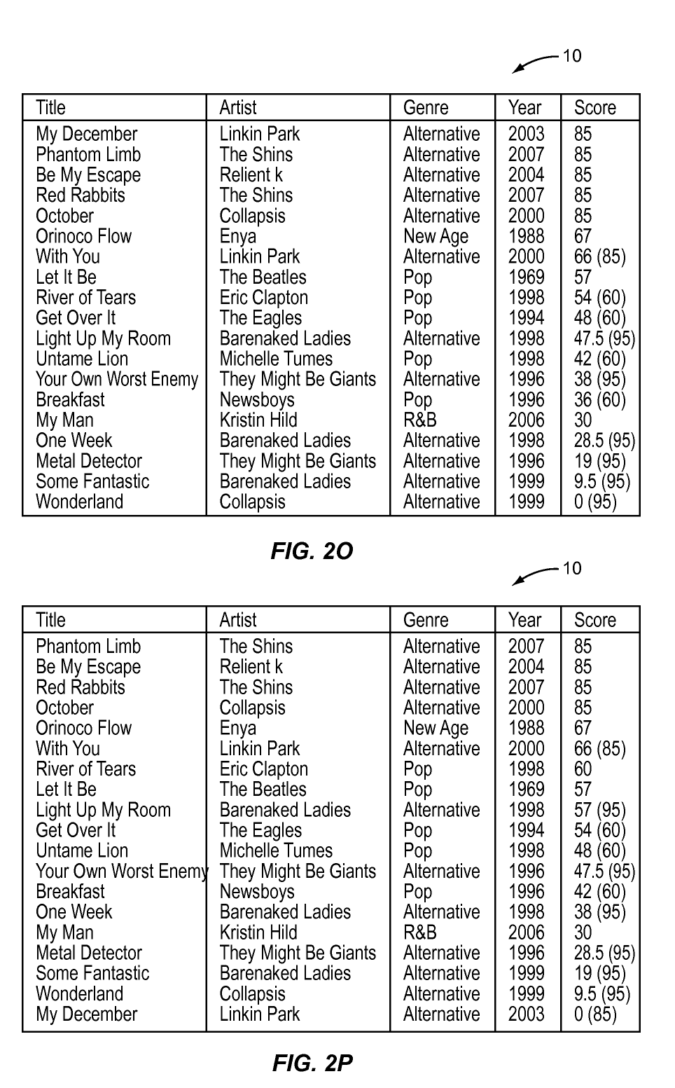

FIGS. 2A through 2E graphically illustrate the process of FIG. 1 according to an exemplary embodiment of the present invention. FIG. 2A illustrates a playlist 10 including a number of scored media items, which in this example are songs. Further, the playlist 10 is sorted based on the scores of the media items. FIG. 2B illustrates the selection of a media item 12 by an associated user, and the movement of the media item 12 down in the playlist 10 by the associated user from an original location in the playlist 10 to a new location in the playlist 10. In this example, the media item 12 selected and moved by the associated user is the song “With You.” The associated user may select and move the media item 12 using, for example, a click-and-drag operation. As a result, the original score (85) of the media item 12 is adjusted by applying a modifier to the original score (85) of the media item 12. The modifier is such that the adjusted score of the media item 12 corresponds to the new location of the media item 12 in the playlist 10. In this example, the modifier is −19 such that the adjusted score of the media item is 66, which is one point lower than the score of the song “Orinoco Flow,” below which the media item 12 was moved. However, in this example, the modifier may have been any value greater than or equal to 60 and less than or equal to 67 such that the media item 12 is properly located between the songs “Orinoco Flow” and “River of Tears” in the sorted playlist 10. FIG. 2C illustrates the playlist 10 after the media item 12 has been selected and moved down in the playlist 10 by the associated user and the appropriate modifier has been applied to the score of the media item 12 as discussed with respect to FIG. 2B.

FIG. 2D illustrates the selection of a group of media items 14 by the associated user, and the movement of the group of media items 14 up in the playlist 10. As a result, modifiers are applied to the original scores of the media items in the group of media items 14. In this example, the group of media items 14 has been moved up above the song “Light Up My Room,” which has a score of 95. As such, modifiers are added to the original scores of the media items in the group of media items 14 such that the adjusted scores of the media items in the group of media items 14 are greater than 95. More specifically, in this example, the original scores of the media items in the group of media items 14 are all 60, and the modifiers applied to the original scores of the media items in the group of media items 14 are all 36 such that the adjusted scores of the media items in the group of media items 14 are all 96. FIG. 2E illustrates the playlist 10 after the group of media items 14 has been moved by the associated user and the appropriate modifiers have been applied to the scores of the media items in the group of media items 14.

FIGS. 2F through 2P illustrate playback of the playlist 10 in a locked-to-top embodiment where the media item at the top of the playlist 10 is selected for playback. After a media item is played, a NRF is applied to the media item such that the same media item is not continuously repeated. More specifically, as illustrated in FIG. 2F, the song “River of Tears” has just completed playback and has been moved to the bottom of the playlist 10 as a result of a NRF. In this example, the NRF is:

$$N R F = \frac{MIN ( 10 , LASTREPEAT\_INDEX )}{10} .$$

Again, the “LASTREPEAT_INDEX” defines a number of media items that have been played from the playlist 10 since the corresponding media item was last played. Thus, since the song “River of Tears” has just been played, the LASTREPEAT_INDEX for that song is zero. As such, the NRF for the song “River of Tears” is also zero, thereby forcing the score of that song to zero (0). Note that in this embodiment, the modifier for the score of the song “River of Tears” is set to zero or is removed immediately in response to the song having been played. Therefore, as discussed below, as playback of the playlist 10 continues, the NRF will increase such that the score of the song “River of Tears” recharges or increases to the original score of 60 rather than the adjusted score of 96.

Since the song “River of Tears” has completed playback and has been moved to the bottom of the playlist 10 as a result of the NRF, the song “Get Over It,” which is now at the top of the playlist 10, is automatically selected for playback. As illustrated in FIG. 2G, once the song “Get Over It” has completed playback, the NRF for the song “Get Over It” is set to zero, thereby forcing the score of the song “Get Over It” to zero. As a result, the song “Get Over It” is moved to the end of the playlist 10. Also, since the LASTREPEAT_INDEX for the song “River of Tears” is now one because one song has played since the song “River of Tears” was last played, the NRF for the song “River of Tears” is now 1/10. As a result, the score of the song “River of Tears” increases to six. Further, once the song “Get Over It” has completed playback and has been moved to the bottom of the playlist 10 as a result of the NRF, the top song in the playlist 10 is then the song “Untame Lion,” which is then automatically selected for playback. From this point, playback continues as illustrated in FIGS. 2H through 2P. Note that once the songs in the group of media items 14 are played, the corresponding NRFs are applied, and the scores of the songs in the group of media items 14 recharge back to their original, unmodified scores of sixty (60) as additional songs from the playlist 10 continue to be played.

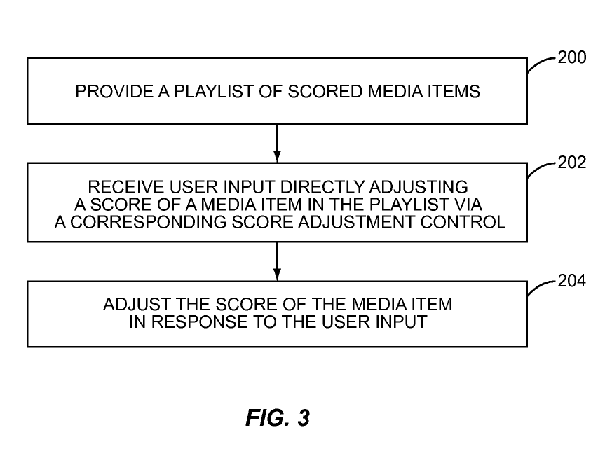

FIG. 3 is a flow chart illustrating a process for affecting a score of a media item in a playlist of scored media items according to another embodiment of the present invention. First, a playlist of scored media items is provided (step 200). In this embodiment, the playlist may or may not be sorted based on the scores of the media items. Again, the media items in the playlist may be scored using any suitable scoring technique for scoring media items based on user preferences of an associated user. As one example, the media items in the playlist may include media items from a media collection of the associated user and media items recommended to the associated user by a number of other users automatically in response to the recommended media items being played by the other users in the manner described in U.S. Patent Application Publication No. 2008/0016205. The media items may then be scored using, for example, the scoring technique disclosed in U.S. Patent Application Publication No. 2008/0016205 as discussed above. However, the present invention is not limited thereto.

In this embodiment, score adjustment controls are provided within or in association with the playlist. Each media item in the playlist has a corresponding score adjustment control. At some point, user input directly adjusting a score of a media item in the playlist is received from the associated user via a corresponding score adjustment control for the media item (step 202). In response to the user input via the score adjustment control for the media item, the score of the media is adjusted (step 204). In one embodiment, the score adjustment is permanent. However, the associated user may thereafter further adjust the score of the media item. In another embodiment, the score adjustment may be temporary. For example, similar to the embodiment discussed above with respect to FIG. 1 and FIGS. 2A through 2P, a modifier may be generated and applied to an original score of the media item to provide an adjusted score for the media item. The adjusted score may then be gradually readjusted to the original score, readjusted to the original score in response to an event such as playback of the media item, or a combination thereof.

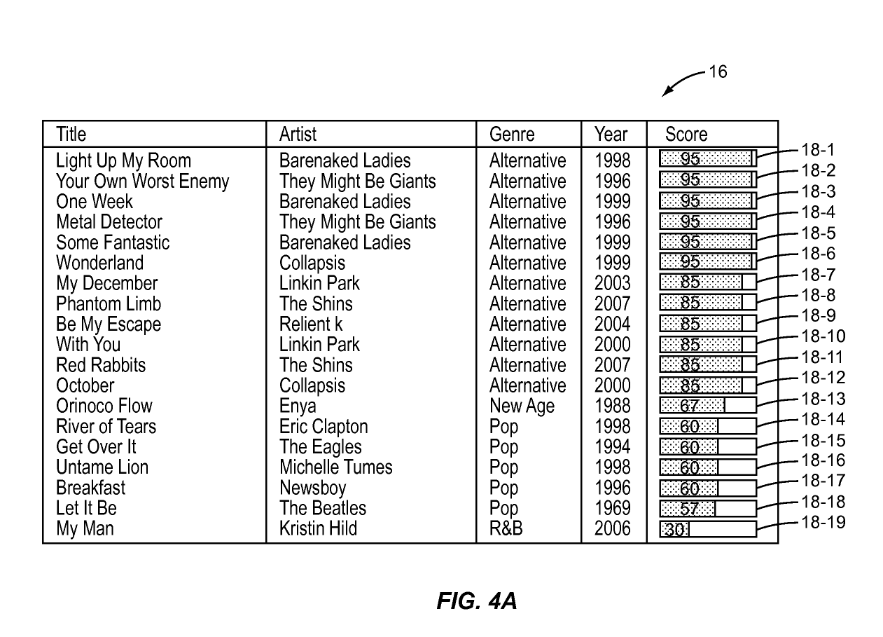

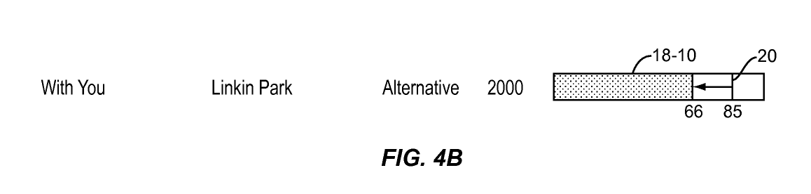

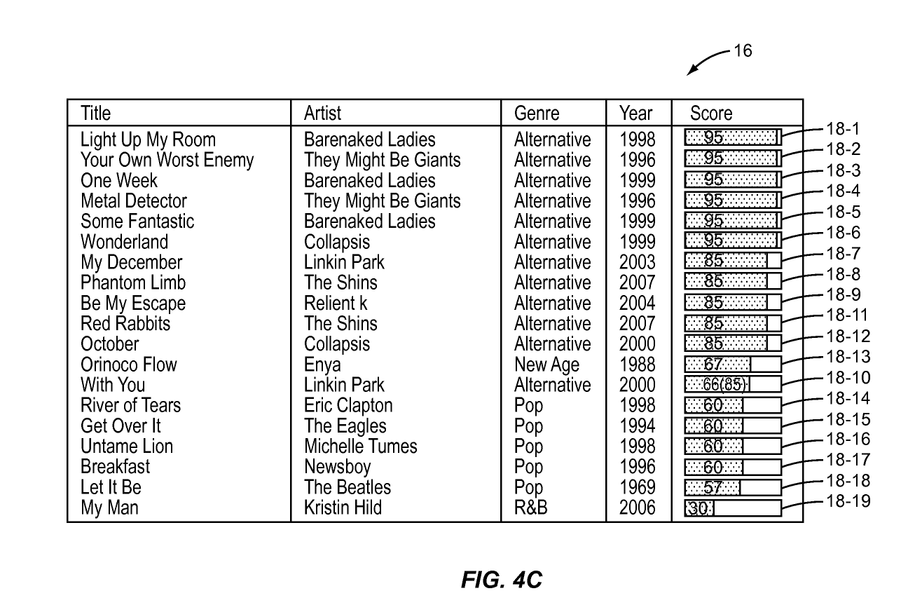

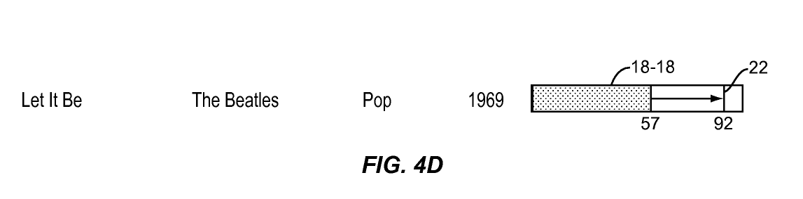

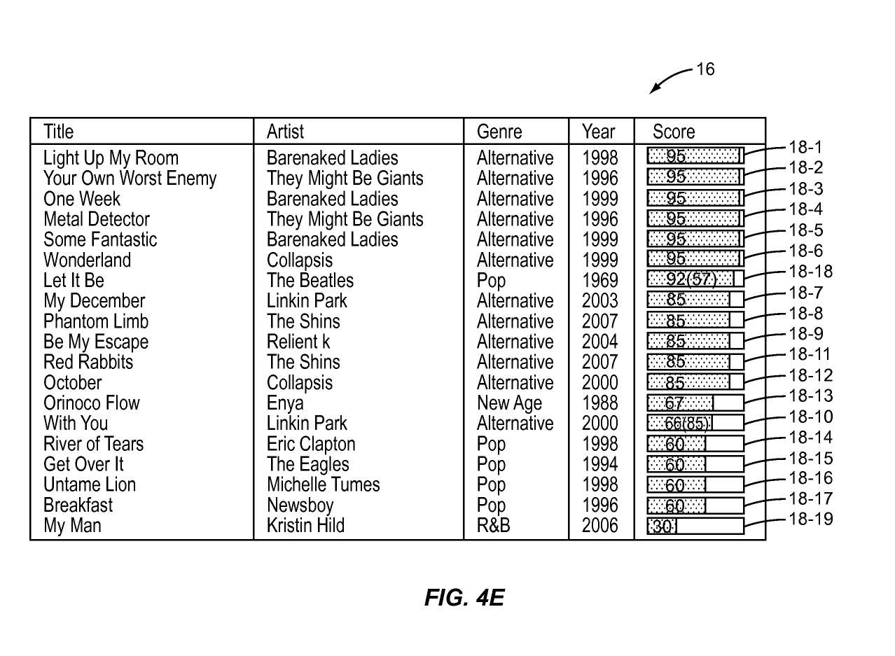

FIGS. 4A through 4E graphically illustrate the process of FIG. 3 according to an exemplary embodiment of the present invention. FIG. 4A illustrates a playlist 16. Media items in the playlist 16 have corresponding score adjustment controls 18-1 through 18-19. In this embodiment, the score adjustment controls 18-1 through 18-19 also serve as score indicators for the corresponding media items in the playlist 16. However, the present invention is not limited thereto. In an alternative embodiment, the score adjustment controls 18-1 through 18-19 may be separate from score indicators for the media items in the playlist 16. The score adjustment controls 18-1 through 18-19 may be part of the playlist 16 or may be separate from the playlist 16.

In this example, an associated user utilizes the score adjustment control 18-10 to directly adjust the score of the song “With You.” More specifically, as illustrated in FIG. 4B, the associated user may click-and-drag a right edge 20 of the score adjustment control 18-10 in order to adjust the score of the song “With You.” As shown, the associated user has moved the right edge 20 of the score adjustment control 18-10 to the left such that the score of the song “With You” is reduced from 85 to 66. The playlist 16 is then updated as shown in FIG. 4C. In this example, the playlist 16 is sorted based on the scores of the media items. As such, in response to the associated user adjusting the score of the song “With You,” the playlist 16 is updated such that the song “With You” is relocated to the appropriate location within the playlist 16. Note that in this example, the score adjustment control 18-10 operates as a score indicator for the song “With You” and reflects both an original score of the song “With You” and the adjusted score of the song “With You.” However, in an alternative embodiment, only the adjusted score may be indicated. This may be particularly beneficial where the adjustment to the score is permanent.

Similarly, as illustrated in FIG. 4D, the associated user selects a right edge 22 of the score adjustment control 18-18 of the song “Let It Be” and moves the right edge 22 to the right to increase the score of the song “Let It Be.” In this example, the associated user has increased the score of the song “Let It Be” from 57 to 92. The playlist 16 is then updated as shown in FIG. 4E. Again, in this example, the playlist 16 is sorted based on the scores of the media items. As such, in response to the user adjusting the score of the song “Let It Be,” the playlist 16 is updated such that the song “Let It Be” is relocated to the appropriate location within the playlist 16. Note that in this example, the score adjustment control 18-18 operates as a score indicator for the song “Let It Be” and reflects both an original score of the song “Let It Be” and the adjusted score of the song “Let It Be.” However, in an alternative embodiment, only the adjusted score may be indicated. This may be particularly beneficial where the adjustment to the score is permanent.

Note that the processes of FIGS. 1 and 3 may be combined into a single embodiment. More specifically, in an exemplary combined embodiment, moving a media item up or down in a playlist may provide a temporary adjustment to the score of that media item, whereas adjusting a score of a media item via a corresponding score adjustment control may provide a permanent adjustment to the score of that media item.

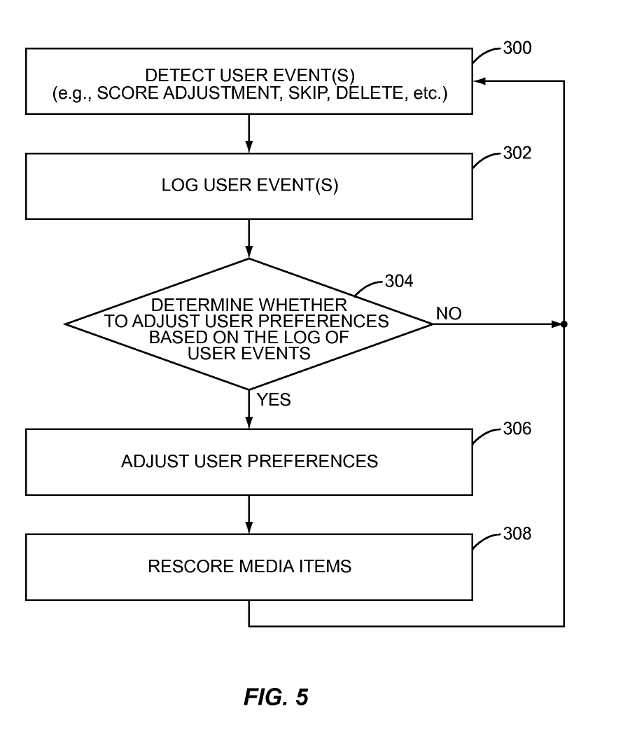

FIG. 5 illustrates a process for adjusting user preferences based on user events including score adjustment events. First, one or more user events are detected with respect to a playlist of scored media items (step 300). Again, in this example, the playlist includes media items scored based on user preferences. Any suitable process for scoring media items based on user preferences may be used. The one or more detected user events may include one or more score adjustment events. A score adjustment event may be a score adjustment event wherein an associated user moves a media item up or down in the playlist to adjust the score of the media item or a score adjustment event wherein the associated user adjusts the score of a media item in the playlist via a corresponding score adjustment control. In addition to detecting score adjustment events, other user events may also be detected. For example, the one or more user events detected in step 300 may include a user event wherein the associated user has skipped over a media item in the playlist, played all or substantially all of a media item in the playlist, deleted or otherwise removed a media item from the playlist, or the like.

In response to detecting the one or more user events, the one or more user events are recorded in a user event log (step 302). The user event log is a historical record of user events that have been detected for at least some predetermined period of time. For each user event, the user event log may include information identifying the type of user event (e.g., score adjustment, media item skip, or the like) and metadata or information describing the media item with respect to which the user event occurred. For example, if the score of a song in the playlist is adjusted, the metadata describing the song may include a title of the song, an artist of the song, an album on which the song was released, a genre of the song, a date that the song was released, or the like. Further, if the playlist is maintained in a recommendation system such as the one disclosed in U.S. Patent Application Publication No. 2008/0016205, the metadata may also include an availability of the song and information identifying a user that recommended the song or, if the song is from the local media collection of the associated user, identifying the associated user. In addition, the user event log may include information identifying a magnitude of each user event if applicable. For example, for a score adjustment event, the magnitude of the score adjustment event may be, or may be related to, a difference between the original score of the corresponding media item and the adjusted score of the corresponding media item where a sign (±) of the difference indicates whether the original score was increased or decreased to provide the adjusted score.

Next, based on the user event log, a determination is made as to whether to adjust the user preferences of the associated user that are used to score the media items in the playlist (step 304). The determination is preferably made based on all user events recorded in the user event log. However, in an alternative embodiment, the determination may be made based on only the user events detected in step 300. In general, the user event log is analyzed with respect to one or more predefined rules in order to determine whether any of the user preferences used for scoring the media items should be adjusted. More specifically, in one embodiment, metadata for the media items with respect to which the user events recorded in the user event log have occurred is correlated. Then, based on the results of the correlation and one or more predefined rules, a determination is made as to whether to adjust the user preferences of the associated user and, if so, which user preferences to adjust.

For example, the correlation of the metadata for the media items with respect to which user events have been detected may indicate that the associated user has frequently decreased the scores of songs from the Country genre. As such, a determination may be made to decrease a weight assigned to the Country genre as a function of the magnitudes of the score adjustment events for songs from the Country genre. As another example, the correlation may indicate that the associated user has frequently increased the scores of songs from the 1980s and has frequently decreased songs from the Country genre. As such, a determination may be made to increase a weight assigned to the 1980s as a function of the magnitudes of the score adjustment events for songs from the 1980s and to decrease a weight assigned to the Country genre as a function of the magnitudes of the score adjustment events for songs from the Country genre. Note that the examples give above are for illustrative purposes only and are not intended to limit the scope of the present invention. Numerous variations for the types of rules and the complexity of the rules used in making the determination as to whether to adjust the user preferences based on the user event log will be apparent to one of ordinary skill in the art and are to be considered within the scope of the present invention.

If a determination is made not to adjust the user preferences, the process returns to step 300. If a determination is made to adjust the user preferences, the user preferences are adjusted (step 306). The user preferences to be adjusted are preferably identified as part of the process for determining whether to adjust the user preferences. The degree to which the identified user preferences are adjusted may be a predetermined amount or may be determined based on the magnitude(s) of the pertinent user event(s). For example, if the user preferences are expressed as weights assigned to a number of metadata categories and weights assigned to attributes for each of those metadata categories, the determination may be made to adjust the weights assigned to one or more metadata categories and/or weights assigned to one or more attributes of one or more metadata categories. Further, the amount by which the weights are adjusted may be a predetermined amount or an amount determined based on the magnitudes of the related user events.

In one embodiment, when adjusting the user preferences, an influence of the user events on the user preferences, and thus the degree of adjustment in the user preferences, may decrease over time. More specifically, initially, the influence of the user events on the user preferences may be the greatest. The influence of the user events may gradually decrease over time such that adjustments made to the user preferences as a result of detected user events become increasingly smaller as the user preferences approach the desired user preferences of the associated user. For example, if the user preferences are expressed as weights in the range of 1 to 10, the influence of the user events may initially be such that adjustments to the weights are on the order of a whole point. However, over time the influence of the user events may decrease such that adjustments to the weights are on the order of tenths or hundredths of a point.

In one embodiment, multiple sets of user preferences may be defined.

Each set of user preferences may be referred to as a channel. For example, the associated user may define user preferences for an “80s Rock” channel, user preferences for a “Pop” channel, and the like. Then, if the user preferences for the “80s Rock” channel are being used to score the media items in the playlist, the user event log may be analyzed to determine whether to adjust the scores of the user preferences by switching from the “80s Rock” channel to another channel. Thus, if the user events in the user event log indicate that the user's current likes and dislikes are more in line with the user preferences for the “Pop” channel, the system may switch to the “Pop” channel. Switching from one channel to another may be viewed as a rough tuning process. Thereafter, the user preferences for the current channel may be further adjusted based on detected user events to fine tune those user preferences.

Once the user preferences are adjusted, at least a subset of the media items in the playlist are rescored based on the adjusted user preferences (step 308). In one embodiment, all media items in the playlist are rescored. In another embodiment, only those media items affected by the adjustments to the user preferences are rescored.

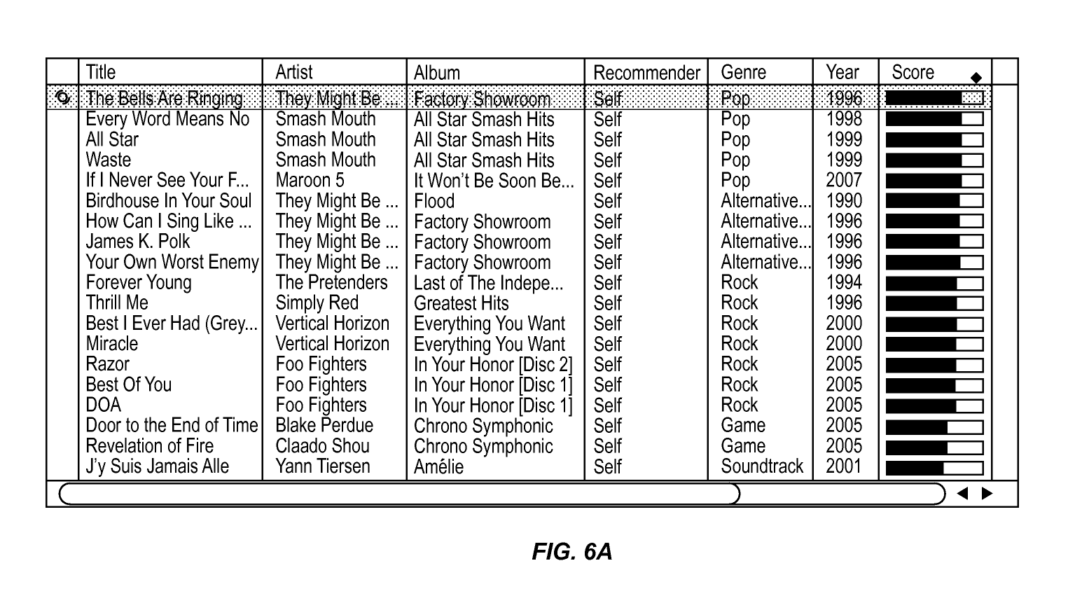

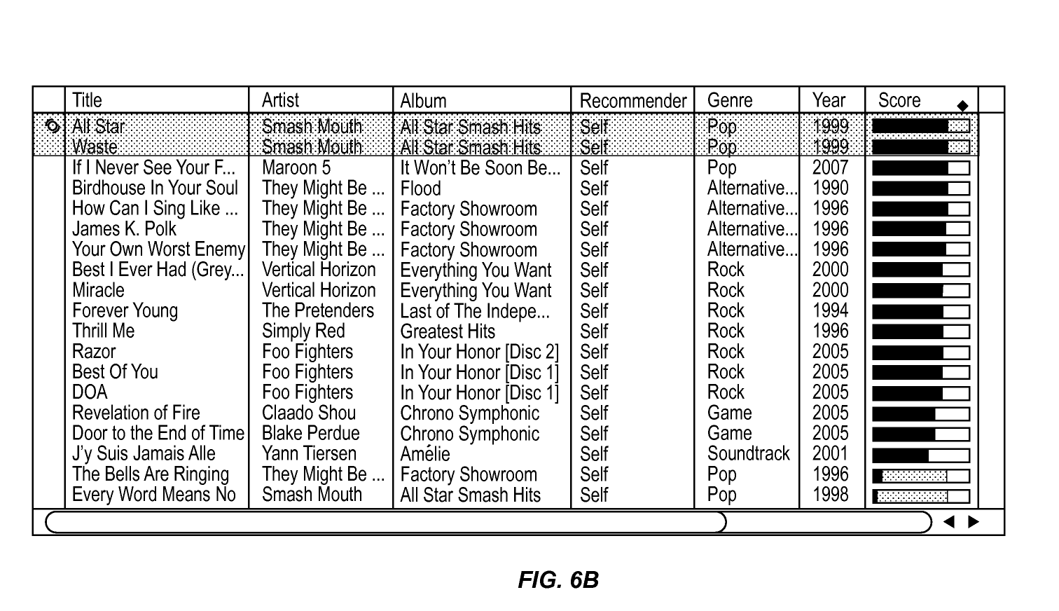

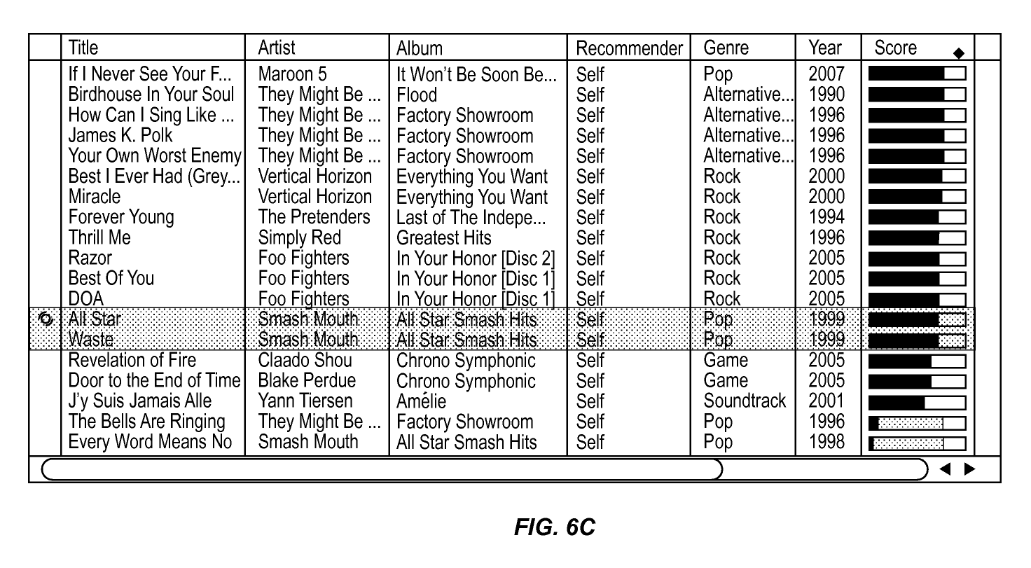

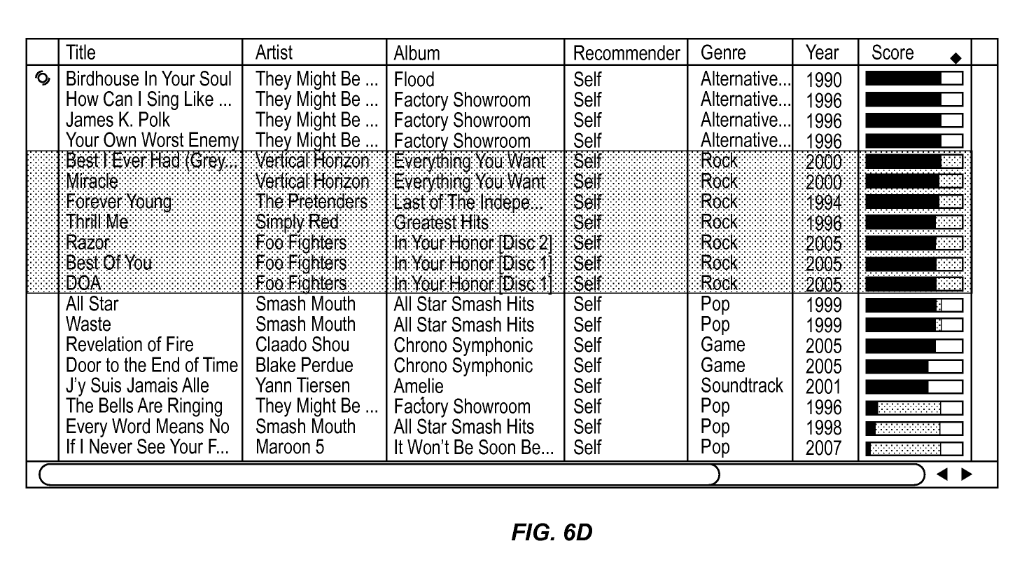

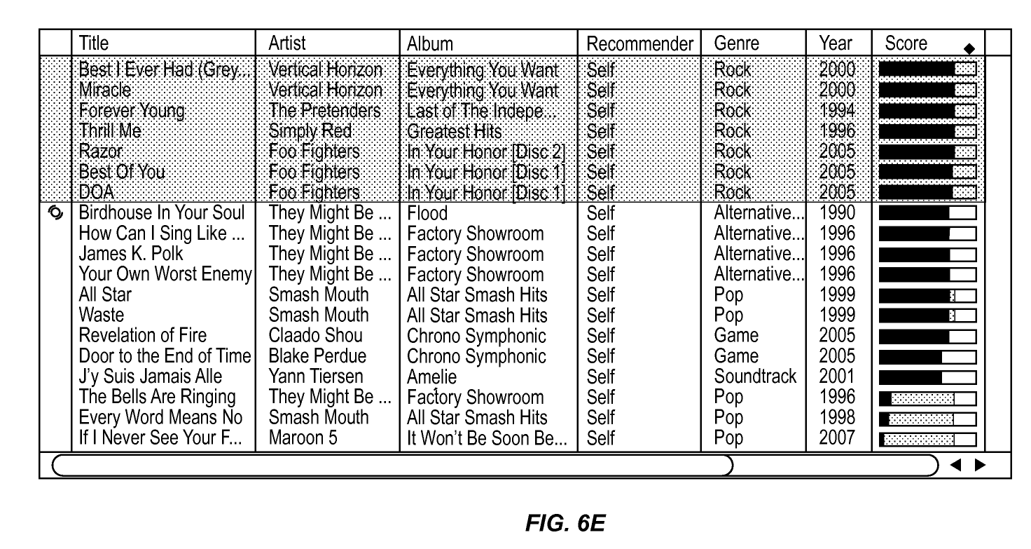

FIGS. 6A through 6E illustrate an exemplary use case for the process of FIG. 5. As illustrated in FIG. 6A, the first song in the playlist begins playing. The first song is by the artist They Might Be Giants. The associated user is not in the mood for They Might Be Giants, so he skips to the next song. The skip event is detected as a user event and recorded in the user event log. Assuming that this is the first detected user event, the user event log does not yet contain enough information to affect the user's preferences. As such, a determination is made not to adjust the user preferences of the associated user at this time.

The next song in the playlist, which is “Every Word Means No” by Smash Mouth, starts playing. The associated user is not in the mood for this song either and therefore again skips to the next song. The skip event is detected as a user event and recorded in the user event log. The system now has two user events in the user event log. The two songs skipped were from the same genre and the same decade. As such, as a result of a correlation of the metadata for these the two songs, the genre (Pop) and decade (1990s) of the songs may be identified as potential user preferences to adjust. Since a relatively small number of user events have been detected, only a small adjustment is made to decrease the weight assigned to the Pop genre. However, since the decade user preference has a much broader implication than genre, the system decides to wait for more user events before deciding to adjust the weight assigned to the 1990s decade. The small adjustment to the weight assigned to the Pop genre is not enough to change the ordering of the playlist.

After “Every Word Means No” is skipped, the next song, which is “All Star,” begins playing. The song “All Star” is another song by Smash Mouth, and the associated user decides that he does not want to listen to songs by Smash Mouth. As such, as illustrated in FIGS. 6B and 6C, the associated user selects the songs “All Star” and “Waste,” which are both by Smash Mouth, and moves them down in the playlist. As such, as discussed above, the appropriate modifiers are generated and applied to the scores of the songs “All Star” and “Waste.” The score adjustments are detected and recorded as separate user events. So far, the correlation of the metadata for the songs skipped and the songs rescored reveals that all of these songs are from the Pop genre and from the 1990s decade. In addition, three of the four songs are by the same artist and from the same album. Since there is ambiguity as to whether the user events occurred as a result of the genre, the decade, the artist, or the album, a determination is made to not adjust the user preferences at this time.

As illustrated in FIG. 6C, after the associated user has moved the songs “All Star” and “Waste” down in the playlist, the next song in the playlist, which is “If I Never See Your Face Again” by Maroon 5, begins playback. The associated user allows this song to play all the way through. Playback of the entire song is detected as a user event, and the user event is recorded in the user event log. The song “If I Never See Your Face Again” is from the same genre as all of the previous songs but is from a different decade. Since playback of the entire song is a positive event, the weight assigned to the Pop genre may be increased. The increase to the weight of the Pop genre may be less than the previous decrease. Note that if the same song is played all the way through in the future or if more songs from the same artist or album are played all the way through in the future, these future user events will result in further increases in the weight assigned to the Pop genre. However, since these events would be positive events for the same song or for songs by the same artist or from the same album, the resulting increments to the weight assigned to the Pop genre will preferably become increasingly smaller. At this point, the system still does not have a large enough variation of data to respond to the differences in decades of the songs acted on thus far. As such, no decade adjustments are made.

As illustrated in FIG. 6D, after playback of the song “If I Never See Your Face Again” is complete, the song “Birdhouse in Your Soul” by They Might Be Giants begins playback. The associated user is still not in the mood for They Might Be Giants. As such, the associated user selects several songs in the playlist from the Rock genre and moves them to the top of the playlist as illustrated in FIG. 6E. As such, modifiers are generated and applied to the scores of those songs in the manner described above. The score adjustments for the selected songs are detected as separate user events and recorded in the user event log. Note that score adjustments may be given greater weight than other types of user events when determining whether to adjust the user preferences of the associated user. Each song moved causes an increment to the Rock genre. As discussed above, in one embodiment, the increment is increasingly diminished for songs by the same artist or even more substantially diminished for songs from the same album.

The associated user allows the top two songs by Vertical Horizon to play in their entireties. These complete playbacks are detected as user events, recorded in the user event log, and result in increments to the weight assigned to the Rock genre. The increment for the song “Miracle” is preferably substantially less than the increment for the song “Best I Ever Had (Grey Sky Morning)” since the song “Miracle” is by the same artist and from the same album as “Best I Ever Had (Grey Sky Morning).” The associated user then decides to skip the songs “Forever Young” and “Thrill Me.” These skip events are detected and recorded. At this point, user events have been detected for songs in the 1990s and 2000s for two different genres (Pop and Rock). Since every negative user event has been with respect to songs from the 1990s, the weight assigned to the 1990s is decreased.

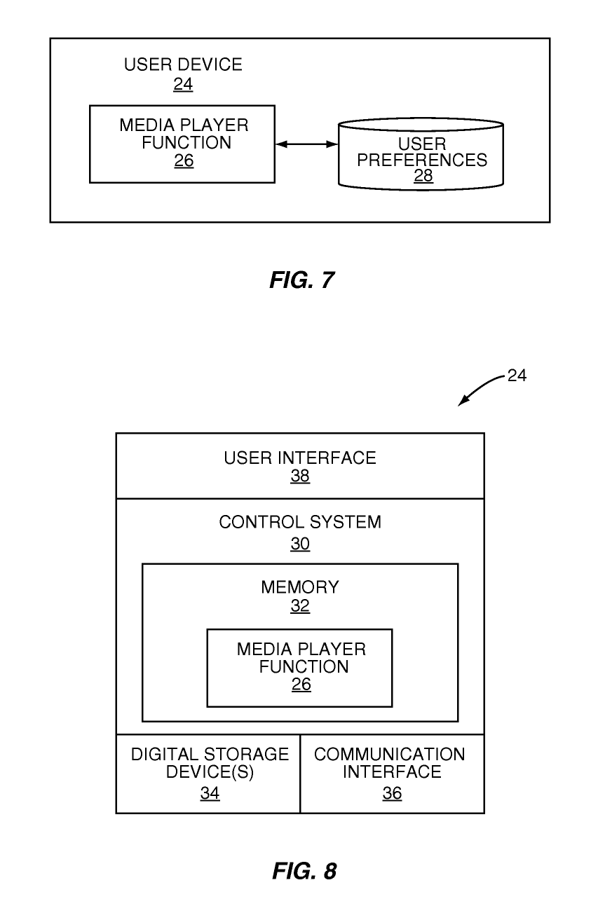

FIG. 7 illustrates a user device 24 including a media player function 26 enabling an associated user to affect scores of media items in a playlist according to one embodiment of the present invention. The user device 24 may be, for example, a personal computer, a mobile smart phone having media playback capabilities, a portable media player, or the like. The media player function 26 may be implemented in hardware, software, or a combination thereof. In general, the media player function 26 provides a playlist of scored media items and enables the associated user to adjust the scores of the media items in the playlist by moving the media items up or down in the playlist as discussed above with respect to FIG. 1 and/or by providing input via corresponding score adjustment controls as discussed above with respect to FIG. 3. In addition, the media player function 26 may detect user events and adjust user preferences 28 of the associated user based on the detected user events as discussed above with respect to FIG. 5.

The media items in the playlist(s) provided by and played by the media player function 26 may include media items stored locally by the user device 24. In addition or alternatively, the playlist(s) provided by and played by the media player function 26 may include media items identified by media recommendations received from one or more user devices of other users. As an example, the media recommendations may be provided to the user device 24 in the manner disclosed in U.S. Patent Application Publication No. 2008/0016205.

FIG. 8 is a block diagram of the user device 24 of FIG. 7 according to one embodiment of the present invention. In general, the user device 24 includes a control system 30 having associated memory 32. In this example, the media player function 26 is implemented in software and stored in the memory 32. However, the present invention is not limited thereto. The user device 24 may also include one or more digital storage devices 34 such as, for example, a hard disk drive, flash memory, or the like. The user preferences 28 (FIG. 7) may be stored in the one or more digital storage devices 34 or the memory 32. In addition, media items may be stored in the one or more digital storage devices 34 or the memory 32. The user device 24 may include a communication interface 36 such as, for example, a mobile telecommunications interface, an Ethernet interface, a WiFi interface, or the like. Lastly, the user device 24 includes a user interface 38, which includes a display, one or more user input devices, a speaker, and the like.

The present invention offers substantial opportunity for variation. For example, the manner in which media items in a playlist are scored may vary. Any suitable scoring technique may be used. Further, while the media items are preferably scored based on user preferences, the present invention is not limited thereto. Additional or alternative criteria may be used for the scoring process. As another example, while the discussion of FIGS. 3 and FIGS. 4A through 4E focuses on an embodiment where a separate score adjustment control is provided for each media item in the playlist, the present invention is not limited thereto. In an alternative embodiment, a single score adjustment control may be shared by all media items in the playlist. More specifically, an associated user may select a media item in the playlist and then adjust the score of that media item via a shared score adjustment control. In other words, the shared score adjustment control is utilized by the associated user to adjust the score of a selected media item in the playlist.

Further, while FIGS. 7 and 8 illustrate a user device 24 implementing one of more of the processes of FIGS. 1, 3, and 5, the present invention is not limited thereto. For example, a central server may maintain a playlist for a user and stream media items in the playlist to a user device of the user. The central server may enable the user to adjust scores of media items in the playlist using the process of FIG. 1 and/or the process of FIG. 3. The central server may also adjust the user preferences of the user based on detected user events as discussed with respect to FIG. 5.

Those skilled in the art will recognize improvements and modifications to the preferred embodiments of the present invention. All such improvements and modifications are considered within the scope of the concepts disclosed herein and the claims that follow.

What is claimed is:

1. A method comprising:
providing a playlist including a plurality of media items that are scored as a function of user preferences of an associated user, the playlist being sorted based on scores of the plurality of media items;
receiving, from the associated user, user input selecting a media item from the plurality of media items in the playlist;
receiving, from the associated user, user input moving the media item within the playlist such that the media item is moved from an original location of the media item in the playlist to a new location of the media item in the playlist; and
adjusting a score of the media item to provide an adjusted score for the media item such that the adjusted score for the media item corresponds to the new location of the media item in the playlist.

2. The method of claim 1 wherein the adjusted score is a function of the original location of the media item in the playlist and the new location of the media item in the playlist.

3. The method of claim 1 wherein:
receiving user input moving the media item within the playlist comprises receiving user input moving the media item up in the playlist; and
adjusting the score of the media item to provide the adjusted score for the media item comprises increasing the score of the media item to provide the adjusted score for the media item.

4. The method of claim 3 wherein:
receiving user input moving the media item up in the playlist comprises receiving user input moving the media item up in the playlist above a second media item; and
increasing the score of the media item comprises increasing the score of the media item such that the adjusted score for the media item is greater than or equal to a score of the second media item.

5. The method of claim 3 wherein:
receiving user input moving the media item up in the playlist comprises receiving user input moving the media item up in the playlist between a second media item and a third media item, a score of the second media item being less than or equal to a score of the third media item; and
increasing the score of the media item comprises increasing the score of the media item such that the adjusted score for the media item is greater than or equal to the score of the second media item and less than or equal to the score of the third media item.

6. The method of claim 1 wherein:
receiving user input moving the media item within the playlist comprises receiving user input moving the media item down in the playlist; and
adjusting the score of the media item to provide the adjusted score for the media item comprises decreasing the score of the media item to provide the adjusted score for the media item.

7. The method of claim 6 wherein:
receiving user input moving the media item down in the playlist comprises receiving user input moving the media item down in the playlist below a second media item; and
decreasing the score of the media item comprises decreasing the score of the media item such that the adjusted score for the media item is less than or equal to a score of the second media item.

8. The method of claim 6 wherein:
receiving user input moving the media item down in the playlist comprises receiving user input moving the media item down in the playlist between a second media item and a third media item, a score of the second media item being greater than or equal to a score of the third media item; and
decreasing the score of the media item comprises decreasing the score of the media item such that the adjusted score for the media item is less than or equal to the score of the second media item and greater than or equal to the score of the third media item.

9. The method of claim 1 wherein adjusting the score of the media item to provide the adjusted score for the media item comprises applying a modifier to the score of the media item to provide the adjusted score for the media item.

10. The method of claim 9 wherein the modifier is an additive modifier.

11. The method of claim 1 wherein adjusting the score of the media item to provide the adjusted score for the media item comprises temporarily adjusting the score of the media item to provide the adjusted score for the media item.

12. The method of claim 10 wherein temporarily adjusting the score of the media item to provide the adjusted score for the media item comprises:
applying a temporary modifier to the score of the media item to provide the adjusted score for the media item; and
gradually removing the temporary modifier over time.

13. The method of claim 10 wherein temporarily adjusting the score of the media item to provide the adjusted score for the media item comprises:
applying a temporary modifier to the score of the media item to provide the adjusted score for the media item; and
removing the temporary modifier after the media item has been played.

14. The method of claim 1 wherein adjusting the score of the media item to provide the adjusted score for the media item comprises permanently adjusting the score of the media item to provide the adjusted score for the media item.

15. A method comprising:
providing a playlist including a plurality of media items that are scored as a function of user preferences of an associated user;
receiving, from the associated user, user input directly adjusting a score of a media item from the plurality of media items in the playlist via a score adjustment control associated with the media item; and
adjusting the score of the media item in response to the user input via the score adjustment control associated with the media item.

16. The method of claim 15 wherein a separate score adjustment control is provided for each media item of the plurality of media items in the playlist.

17. The method of claim 15 wherein adjusting the score of the media item comprises permanently adjusting the score of the media item.

18. The method of claim 15 wherein adjusting the score of the media item comprises temporarily adjusting the score of the media item.

19. A method comprising:
providing a playlist including a plurality of media items that are scored as a function of user preferences of an associated user;
detecting one or more user events with respect to the playlist;
adjusting the user preferences of the associated user based on the one or more user events to provide adjusted user preferences for the associated user; and
rescoring at least a subset of the plurality of media items in the playlist based on the adjusted user preferences.

20. The method of claim 19 further comprising recording the one or more user events in a user event log, and wherein adjusting the user preferences of the associated user comprises:
analyzing a plurality of user events recorded in the user event log including the one or more user events to make a determination as to whether to adjust the user preferences of the associated user; and
adjusting the user preferences based at least a subset of the plurality of user events recorded in the user event log if the determination is made to adjust the user preferences of the associated user.

21. The method of claim 20 wherein the user event log includes metadata describing media items with respect to which the plurality of user events occurred, and analyzing the plurality of user events comprises:
correlating the metadata describing the media items with respect to which the plurality of user events occurred; and
identifying one or more user preferences from the user preferences of the associated user to adjust based on results of correlating the metadata describing the media items with respect to which the plurality of user events occurred.

22. The method of claim 19 further comprising repeating the steps of detecting one or more user events with respect to the playlist and adjusting the user preferences of the associated user based on the one or more user events.

23. The method of claim 22 wherein an influence of user events on the user preferences of the associated user decreases over time.

24. The method of claim 19 wherein the one or more user events comprise one or more score adjustment events.

25. The method of claim 24 wherein the playlist is sorted based on scores of the plurality of media items, and the one or more score adjustment events comprise a score adjustment event in which the associated user adjusts a score one of the plurality of media items in the playlist by moving the one of the plurality of media items within the playlist.

26. The method of claim 24 wherein the one or more score adjustment events comprise a score adjustment event in which the associated user directly adjusts a score of one of the plurality of media items in the playlist via an associated score adjustment control.

27. The method of claim 24 wherein the one or more user events further comprise at least one of a group consisting of: a skip event indicating that the associated user has skipped a corresponding media item in the playlist, a complete playback event indicating that the associated user has permitted complete playback of a corresponding media item in the playlist, and a delete event indicating that the associated user has deleted a corresponding media item from the playlist.
